(19) United States
(12) Patent Application Publication
(10) Pub. No.: US 2004/0224064 A1
(43) Pub. Date: Nov. 11, 2004

(54) Apple french fries

(76) Inventors: Richard A. Shepherd, Kennewick, WA (US); Rick Shearer, Royal City, WA (US)

Correspondence Address: Richard C. Litman, LITMAN LAW OFFICES, LTD., P.O. Box 15035, Arlington, VA, 22215, US

(21) Appl. No.: 10/806,137

(22) Filed: Mar. 23, 2004

Related U.S. Application Data
(60) Provisional application No. 60/468,110, filed on May 6, 2003.

(51) Int. Cl. A23L 1/216

(52) U.S. Cl. 426/482

(57) ABSTRACT

Apple French fries are provided for fast food and restaurant businesses to sell a unique product. Apples, preferably tart apples such as Granny Smith apples, are cleaned, peeled, cored, cut into French fry pieces of varying shapes (e.g., strips, wedges, cubes, rings or spirals), watered preferably by misting, coated thinly with a corn starch and rice flour, frozen, and then packaged in certain quantities, for delivery to businesses.

### CROSS-REFERENCE TO RELATED APPLICATION

This application claims the benefit of U.S. Provisional Patent Application Ser. No. 60/468,110, filed May 6, 2003.

### BACKGROUND OF THE INVENTION

1. Field of the Invention

The present invention relates generally to food. More specifically, the invention is a method of making apple French fries by beginning with slicing whole apples into various shapes, such as strips, wedges, cubes, rings or spirals, spraying water on the pieces, coating the slices with a corn starch and rice flour powder, and freezing the coated pieces for storage.

2. Description of the Related Art

A simple preparation of tasty French fried apple pieces which are easily prepared, stored and cooked, would be a delicious addition to the menu of any fast food restaurant or stock of any grocery store. The relative art of interest describes various French fried foods and a number of recipes and snacks involving the frying of apples, potatoes and other foods, but none discloses the present invention.

http://www.mouseplanet.com/lig/food.htm, 3 pp., a website of Lego-land's Amusement Park, shows a “Granny Apple Fry” recipe in which apples are prepared like French fries, then sprinkled with cinnamon sugar. The process is distinguishable for requiring cinnamon sugar flavoring.

U.S. Pat. No. 6,268,353 B1 issued on Jul. 31, 2001, to Hiroto Chaen et al. describes a method for inhibiting the formation of volatile aldehydes and/or the decomposition of fatty acids in the production of fried apple slices by soaking the slices in an aqueous saccharide and salted solution, freezing the slices, and frying them in deep fat. The process is distinguishable for requiring saccharide and salt.

US Patent Application Publication No. 2003/0044488 A1, published on Mar. 6, 2003, for Robert 0. Roskam et al. describes coating type compositions for sweet goods including the addition of a starch-component base prior to cooking. The compositions are distinguishable for being generic to many foods.

http;//www.oreida.com/recipes/hotapplefry.jsp, Website of Ore-Ida Funky Favorites, 1 pg. describing a recipe for Hot Apple Fry pie filling that includes after oven cooking apple slices at 375 degrees F., cut into half-inch pieces, add brown sugar, and bake in a pie plate for 20 minutes. The composition is distinguishable for requiring brown sugar.

http;//www.ebounds4all.com/203353/messages/2414.html, Website of Darlenes's Kichen Pantry, 2 pp., describing a recipe for baked Roman apple fries by adding sugar, ground cinnamon, apricot jam, and red food coloring. The composition is distinguishable for requiring sugar, cinnamon, and apricot jam.

U.S. Pat. No. 3,962,355 issued on Jun. 8, 1976, to Tatsuo Yamazaki et al. describes a method of producing dehydrated fried snack food from apples comprising the inactivation of oxidase of apple pieces by frying under a vacuum or atmospheric pressure, and cooling the fried pieces in a vacuum. The method is distinguishable for requiring the use of a vacuum during cooling.

U.S. Pat. No. 4,194,016 issued on Mar. 18, 1980, to Merle L. Weaver et al. describes a process for preparing precooked fruits and vegetables comprising cooking to their centers at a temperature below the temperature at which sloughing of the surface tissue would occur such as 81 to 83 degrees Centigrade. Subsequently, the fruits or vegetables are heated in air and preserved. The process is distinguishable for requiring cooking the fruits and vegetables to their center and cooking.

U.S. Pat. No. 4,514,428 issued on Apr. 30, 1985, to Richard W. Glass et al. describes a crisp apple snack and the process of making same comprising the steeping of apple slices in a sugar solution and rapidly drying to form a snack which may include the apple peel as well as the carpels. The product and process are distinguishable for requiring sugar, rapidly drying and including the apple peel and carpels.

U.S. Pat. No. 4,626,436 issued on Dec. 2, 1986, to Alan B. Bradley et al. describes a frozen block process for vegetable or fruit convenience foods comprising the compression of the cleaned foods into a frozen block, frozen, sawing the block into equal sizes, and further processed by batter coating, cooking and packaging. The process is distinguishable for requiring blocking, refrigeration, sawing into equal sizes, cooking, and packaging.

U.S. Pat. No. 4,889,730 issued on Dec. 26, 1989, to Bruce A. Roberts et al. describes a crisp fruit or vegetable snack product and process for preparing the products comprising soaking pieces in sugar solution, dried in a microwave apparatus at 65 degrees C. and comminuted. The preferred fruits include apples. The fruit powder can be used for human consumption or fodder for animals. The products and process are distinguishable for requiring the soaking of the fruit pieces in a sugar solution

U.S. Pat. No. 4,950,491 issued on Aug. 21, 1990, to Elemer Varga describes a process for preparing powdered fruit comprising the cutting up of fruit such as apples, dried in a microwave apparatus below 65 degrees C., and comminuted. The fruit product is distinguishable for requiring microwaving.

U.S. Pat. No. 5,939,117 issued on Aug. 17, 1999, to Chao Chen et al. describes methods for preserving fresh fruit and the products comprising the application of a fruit preservative solution comprising water, calcium ions, and ascorbate ions, and storing the treated fruit in a low non-freezing temperature between 2 to 5 degrees C. The products and process are distinguishable for requiring the addition of a fruit preservative and storing the treated fruit at a low temperature.

U.S. Pat. No. 5,972,397 issued on Oct. 26, 1999, to Timothy D. Durance et al. describes a method for preparing dried and uncooked potato slices comprising the application of microwave energy under a vacuum to produce dried potato slices having a water activity of less than 0.85. The method is distinguishable for requiring the application of microwave energy under a vacuum.

Japanese Patent Application Publication No. JP 61-227758 A published on Oct. 9, 1986, for Yosuke Tanabe describes a compressed fried apple made by compress-molding the fried apple to reduce the oil content and the oil oxidation, resulting in improved storability. The process is distinguishable for requiring compress-molding to reduce the oil content of fried apples.

French Patent Application Publication No. FR 2 788 940 A1 published on Aug. 4, 2000, for Francois Sarazin describes the preservation of apple slices by dehydration in warm air at 170 degrees C., coated in fat and sugar, caramelizing by frying, and deep frozen. The product and process are distinguishable for requiring caramelizing of apple slices coated with fat and sugar.

None of the above inventions and patents, taken either singly or in combination, is seen to describe the instant invention as claimed. Thus apple French fries solving the aforementioned problems is desired.

### SUMMARY OF THE INVENTION

The apple French fries are prepared from preferably tart apples, e.g., Granny Smith, by peeling the skin, coring the apple, cutting the apples into various shaped pieces such as strips, wedges, cubes, rings or spirals, moistening the pieces with water, applying a thin coating of corn starch and rice flour, packaging pieces by weight, and freezing the packages for future sale to fast food restaurants and the like for French frying in deep fat.

Accordingly, it is a principal object of the invention to provide a method of making fried apples according to the present invention.

It is another object of the invention to provide a method of making these fried apple shapes according to the present invention.

It is a further object of the invention to provide a method of making fried apple shapes precoated with corn starch and rice flour according to the present invention.

Still another object of the invention is to provide a method of making fried apple shapes by frying in deep hot fat according to the present invention.

It is an object of the invention to provide improved elements and arrangements thereof for the purposes described which is inexpensive, dependable and fully effective in accomplishing its intended purposes.

These and other objects of the present invention will become readily apparent upon further review of the following specification.

### DETAILED DESCRIPTION OF THE PREFERRED EMBODIMENTS

The present invention is directed to a method of making apple French fries for distribution to restaurants and the like, to provide a healthy and tasty alternative to potato French fries.

Whole apples are cleaned, the skins are peeled, and the peeled apples are cored to remove the seeds. The cored apples are sliced into strips, wedges, cubes, rings or spirals by a mechanical cutter device. The cuts are watered by a spray and coated with a corn starch and rice flour powder. The coated pieces are frozen for future delivery to restaurants and fast food outlets. The coated pieces can be prepackaged in certain quantities by weight after freezing.

Preferably, the powder for coating the pieces is a mixture consisting essentially of 75% cornstarch and 25% rice powder. Additional minor additives may include coloring and/or preservatives. An even layer of the powder mixture is applied to cover the apple pieces. Preferably, the coating layer is relatively thin. Approximately two ounces of powder per pound of apple pieces can be used, for example.

Once coated, the pieces are frozen. Then the pieces can be prepackaged by predetermined weights, and then sold to restaurants, food stores, fast food outlets, and other retail and wholesale outlets.

Then restaurants and fast food outlets can deep fry the apple pieces with or without condiments, and present the fried apple products to a customer with an optional dipping composition. The apple products will be considered a fast food item available to any restaurant or fast food business. Additionally, the packaged apple products can be marketed to consumers for home deep fat frying and preparation.

It is to be understood that the present invention is not limited to the embodiments described above, but encompasses any and all embodiments within the scope of the following claims.

I claim:

1. Method of making apple French fries, comprising:
cleaning a whole apple;
peeling the whole apple;
coring the whole apple;
slicing the whole apple into predetermined shapes with a mechanical cutter device;
spraying water on the apple pieces;
coating the wet apple pieces with a corn starch and rice flour powder; and
freezing the coated apple pieces for storage.

2. The method according to claim 1, wherein the apple is a Granny Smith apple.

3. The method according to claim 1, wherein the spraying water step comprises moistening the apple pieces with a water mist.

4. The method according to claim 1, wherein the powder consists essentially of a mixture of approximately 75% cornstarch and 25% rice powder.

5. The method according to claim 4, wherein the amount of powder used in coating the apple pieces is determined proportionally according to the weight of the apple pieces being powdered, the ratio being approximately two ounces of powder per pound of apple pieces.

6. The method according to claim 1, wherein the amount of powder used in coating the apple pieces is determined proportionally according to the weight of the apple pieces being powdered, the ratio being approximately two ounces of powder per pound of apple pieces.

7. The method according to claim 1, wherein the predetermined shape of the apple pieces is a strip.

8. The method according to claim 1, wherein the predetermined shape of the apple pieces is a wedge.

9. The method according to claim 1, wherein the predetermined shape of the apple pieces is a cube.

10. The method according to claim 1, wherein the predetermined shape of the apple pieces is a ring.

11. The method according to claim 1, wherein the predetermined shape of the apple pieces is a spiral.
